(19) United States
(12) Patent Application Publication
(10) Pub. No.: US 2026/0341182 A1
(43) Pub. Date: Oct. 29, 2026

(54) KNEE AMPUTATION TRAINING MODEL AND METHODS OF USE

(71) Applicant: AtriCure, Inc., Mason, OH (US)

(72) Inventors: Christopher TAPPE, Mason, OH (US); Drew MASON, Mason, OH (US); Kathe POCKER, 45040, OH (US); Matthew MONTI, Mason, OH (US)

(73) Assignee: AtriCure, Inc., Mason, OH (US)

(21) Appl. No.: 19/369,040

(22) Filed: Oct. 24, 2025

Related U.S. Application Data
(60) Provisional application No. 63/796,951, filed on Apr. 29, 2025.

(51) Int. Cl. G09B 23/30

(52) U.S. Cl. CPC G09B 23/30

(57) ABSTRACT

Disclosed herein are systems and methods for a surgical leg model for teaching surgical skills, including: a first portion representing an upper end; a second portion representing a lower end; a groove between the first portion and the second portion, wherein the groove is breakable to separate the first portion and the second portion; a silicone material within the first portion and the second portion; one or more synthetic nerves within the silicone material; one or more synthetic bones within the silicone material; and a synthetic covering surrounding the first portion and the second portion, wherein the synthetic covering is open at the upper end and the lower end.

### CROSS REFERENCE TO RELATED APPLICATION

This application claims benefit of U.S. Provisional Application Number 63/796,951 filed Apr. 29, 2025, the content of which is incorporated by reference in its entirety.

### FIELD OF TECHNOLOGY

The present disclosure relates generally to the field of surgical training devices, and more specifically, training models for above the knee and below the knee amputations.

### BACKGROUND

Current surgical models for training surgical skills and techniques can be anatomically incorrect, and are generally not portable or versatile in their presentation of nerves and bones. Such shortcomings result in significant difficulties in the training of surgeons for surgical techniques. The positioning of specific nerves, visual indicators for skin and fat under the skin, and the durometer of vessels and muscles all contribute to the quality of a training model. Currently, no simulation training models exist to sharpen surgical skills for both below-the-knee and above-the-knee amputations.

Therefore, there remains a need for methods and devices that are portable, represent life-like characteristics, and are efficient in teaching surgical skills for multiple procedures.

### SUMMARY

In some variations, the techniques described herein relate to a surgical leg model for teaching surgical skills, including: a first portion representing an upper end; a second portion representing a lower end; a groove between the first portion and the second portion, wherein the groove is breakable to separate the first portion and the second portion; a silicone material within the first portion and the second portion; one or more synthetic nerves within the silicone material; one or more synthetic bones within the silicone material; and a synthetic covering surrounding the first portion and the second portion, wherein the synthetic covering is open at the upper end and the lower end.

In some variations, the techniques described herein relate to a surgical leg model, wherein the first portion includes an open upper end and an open lower end visible when the first portion is separated from the second portion.

In some variations, the techniques described herein relate to a surgical leg model, wherein the open upper end resembles a distal view above the knee.

In some variations, the techniques described herein relate to a surgical leg model, wherein the open lower end resembles a proximal view above the knee.

In some variations, the techniques described herein relate to a surgical leg model, wherein the second portion includes an open upper end and an open lower end visible when the second portion is separated from the first portion.

In some variations, the techniques described herein relate to a surgical leg model, wherein the open upper end resembles a distal view below the knee.

In some variations, the techniques described herein relate to a surgical leg model, wherein the open lower end resembles a distal view below the knee.

In some variations, the techniques described herein relate to a surgical leg model, wherein the model includes a base and a recess.

In some variations, the techniques described herein relate to a surgical leg model, wherein the recess is configured to engage with a protrusion on a receiving tray.

In some variations, the techniques described herein relate to a surgical leg model, wherein the second portion includes a simulated patella.

In some variations, the techniques described herein relate to a surgical leg model, wherein the simulated patella includes a harder material than a remainder of the synthetic covering.

In some variations, the techniques described herein relate to a surgical leg model, wherein the synthetic covering is penetrable by a needle.

In some variations, the techniques described herein relate to a surgical leg model, wherein the one or more synthetic nerves are replaceable within the model.

In some variations, the techniques described herein relate to a surgical leg model, wherein the one or more synthetic bones are replaceable within the model.

In some variations, the techniques described herein relate to a surgical leg model, wherein the one or more synthetic nerves are color coded based on their respective nerve.

In some variations, the techniques described herein relate to a surgical leg model for teaching surgical skills, including: a first portion representing an upper end, wherein the first portion includes a first plate; a second portion representing a lower end, wherein the first portion includes a second plate, wherein the second plate couples to the first plate; a muscle flap between the first portion and the second portion, wherein the muscle flap is removable from the first portion and the second portion; a silicone material within the first portion and the second portion; one or more synthetic nerves within the silicone material; and one or more synthetic bones within the silicone material.

In some variations, the techniques described herein relate to a surgical leg model, wherein the first portion includes an open upper end and an open lower end visible when the first portion is separated from the second portion.

In some variations, the techniques described herein relate to a surgical leg model, wherein the open upper end resembles a distal view above the knee, wherein the open lower end resembles a proximal view above the knee.

In some variations, the techniques described herein relate to a surgical leg model, wherein the second portion includes an open upper end and an open lower end visible when the second portion is separated from the first portion.

In some variations, the techniques described herein relate to a surgical leg model, wherein the open upper end resembles a distal view below the knee, wherein the open lower end resembles a distal view below the knee.

### BRIEF DESCRIPTION OF THE DRAWINGS

FIG. 1A illustrates a side view of an exemplary training model according to one variation of the invention.

FIG. 1B illustrates a front view of the training model of FIG. 1A.

FIG. 1C illustrates a back view of the training model of FIG. 1A.

FIGS. 1D and 1E illustrate perspective views of the training model of FIG. 1A.

FIGS. 2A and 2B illustrate front and perspective views of the training model below the knee.

FIGS. 2C and 2D illustrate front and perspective views of the training model above the knee.

FIGS. 3A and 3B illustrate a training model with interlocking parts according to another variation of the present invention.

### DETAILED DESCRIPTION

The exemplary embodiments of the present disclosure are described and illustrated below to encompass exemplary cryogenic devices and, more specifically, encompass cryogenic devices and methods of manufacturing the same, where the cryogenic devices can be used for surgical applications to deliver cooling to one or more tissue locations. In addition, the exemplary embodiments are directed to methods of using cryogenic devices as part of surgical procedures. Of course, it will be apparent to those of ordinary skill in the art that the embodiments discussed below are exemplary in nature and can be reconfigured without departing from the scope and spirit of the present invention. However, for clarity and precision, the exemplary embodiments as discussed below can include optional steps, methods, and features that one of ordinary skill should recognize as not being a requisite to fall within the scope of the present invention.

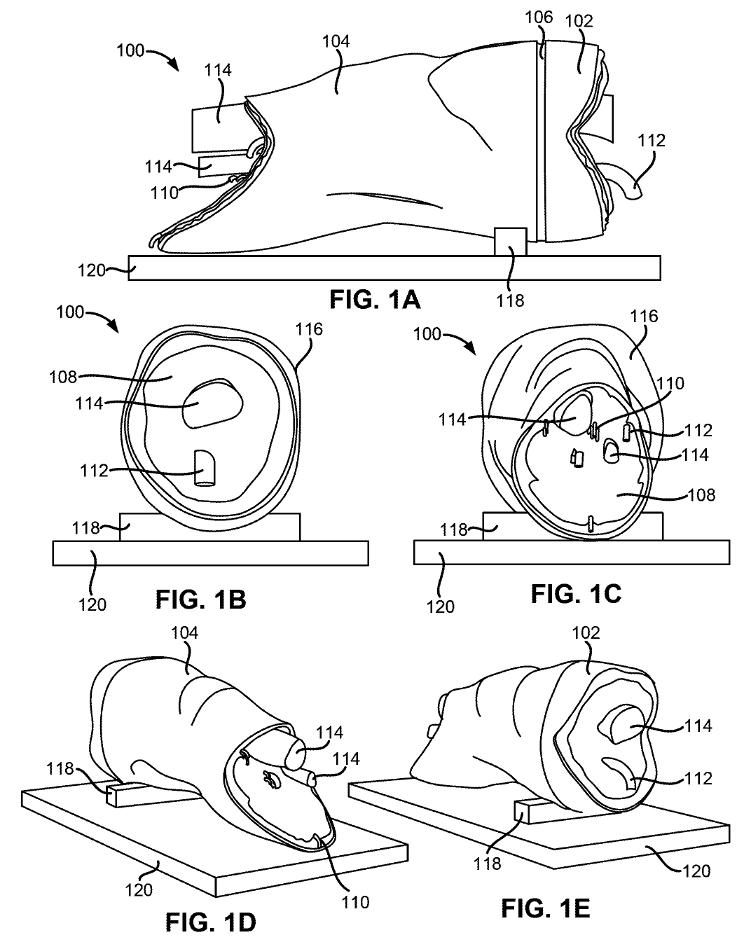

FIG. 1A illustrates a side view of an exemplary training model for teaching surgical skills according to one variation of the invention. The model 100 can comprise a first portion 102, a second portion 104, and a groove 106 between the first portion 102 and the second portion 104. The first portion 102 can represent an upper end of the model. The second portion 104 can represent a lower end of the model.

The model 100 can comprise a material 108 within. The material 108 can resemble one or more muscles within the leg. The material 108 can be packed into the first portion 102 and the second portion 104 to create an air-tight muscle or fat within the model 100. The material 108 can comprise silicone.

The model 100 can further comprise one or more synthetic nerves 110 within. The synthetic nerves 110 can be placed within the material 108 in the first portion 102 and the second portion 104 and can resemble human nerves. The nerves 110 can droop down to resemble human nerves and can have adjustable lengths accordingly. The synthetic nerves 110 can be silicone molds that can be replaceable when worn or damaged.

The model 100 can further comprise one or more synthetic vessels 112 within. The synthetic vessels 112 can be placed within the material 108 in the first portion 102 and the second portion 104 and can resemble human blood vessels. The vessels 112 can droop down to resemble human vessels and can have adjustable lengths accordingly.

The model 100 can further comprise one or more synthetic bones 114 within. The synthetic bones 114 can be placed within the material 108 in the first portion 102 and the second portion 104 and can resemble human bones. The synthetic bones 114 can be 3D printed and made from polylactic acid or other suitable materials.

A synthetic covering 116 can surround the first portion 102 and the second portion 104 to resemble skin. The synthetic covering 116 can comprise a visual indicator (e.g., color) to indicate its border with respect to the material 108 within the model when viewed from the cut end of the limb (i.e., proximal view or distal view). The synthetic covering can be penetrable by a needle. The synthetic covering 116 can serve as an outer shell of the model 100 and can be cast of 3D printed material (e.g., thermoplastic polyurethane, thermoplastic elastomer, polylactic acid).

The synthetic nerves, vessels, and bones can comprise life-like characteristics and parameters such as durometer, length, diameter, and other parameters optimized to resemble human nerves, vessels, and bones. For example, nerve sizes can be made different from each other and colored accordingly, and muscle compartments can comprise various densities, durometers, and elasticities.

The synthetic nerves, vessels, bones can be color coded to differentiate between nerves within the model 100 (i.e., veins can be blue, arteries can be red).

The synthetic nerves, vessels, and bones, can be made of one or a combination of: plastic, silicone, rubber, and/or other materials suitable to represent anatomical features. The first portion 102 and the second portion 104 can be made of plastic, silicone, or a combination thereof.

The synthetic nerves, vessels, and bones, can be replaceable after one or more uses. This can ensure an integrity to materials from degradation after use.

In some variations, the nerves, vessels, bones, and muscles can be frozen. The frozen synthetic parts can appear frozen via a visual indicator or color change within the synthetic parts.

FIG. 1B illustrates a front view of the training model of FIG. 1A. The front view can be representative of a distal view (i.e., down the leg towards the foot). FIG. 1C illustrates a back view of the training model of FIG. 1A. The back view can be representative of a proximal view (i.e., up the leg towards the hip). With the front and the back views, a user can see within the first portion and/or the second portion for training various surgical techniques.

The groove 106 can be breakable to separate the first portion 102 and the second portion 104. When the first portion 102 and the second portion 104 are separated at the groove 106, the first portion 102 is opened to show a first portion distal view and a first portion proximal view and the second portion 104 can be opened to show a second portion distal view and a second portion proximal view. Accordingly, the model 100 can be reversible to show four separate visible views: distal views both below the knee and above the knee and proximal views both below the knee and above the knee. This enables a two-in-one model for both the first portion 102 and the second portion 104 for training purposes. The model 100 can comprise a label or arrow to orient the user with respect to the proximal and distal directions.

In some variations, the user can train a below knee amputation (BKA) operation, which can be performed on the cut end of the leg, after the tibia and fibula are cut and the lower limb is removed. The user can interact with severed ends of nerves and/or vessels. Various nerves can include the tibial nerve, the deep peroneal nerve, the superficial peroneal nerve, the saphenous nerve, and the sural nerve. The nerves can comprise an oval or a circular cross-sectional shape and can have vessels running alongside them for the user to practice separation between the nerves and the vessels. One or more of the nerves can be hidden behind a skin-like flap along the first portion 102 or the second portion 104.

In some variations, the tibial nerve can comprise an exposed length of about 3 inches and a cross-sectional diameter oval shape of about .18 inches wide and .28 inches long.

In some variations, the deep peroneal nerve can comprise an exposed length of about 3 inches and a cross-sectional diameter circular shape of about .16 inches.

In some variations, the super peroneal nerve can comprise an exposed length of about 3 inches and a cross-sectional diameter circular shape of about .18 inches.

In some variations, the saphenous nerve can comprise an exposed length of about 1 inch and a cross-sectional diameter circular shape of about .08 inches.

In some variations, the sural nerve can comprise an exposed length of about 1 inches and a cross-sectional diameter circular shape of about .12 inches.

In some variations, the user can train an above knee amputation (AKA) operation, which can be performed on the cut end of the leg, after the femur is cut and the lower limb is removed. The user can interact with severed ends of nerves and/or vessels. Various nerves can include the sciatic nerve and the femoral nerve. The nerves can comprise an oval or a circular cross-sectional shape and can have vessels running alongside them for the user to practice separation between the nerves and the vessels. One or more of the nerves can be hidden behind a skin-like flap along the first portion 102 or the second portion 104.

In some variations, the sciatic nerve can comprise an exposed length of about 3 inches and a cross-sectional diameter oval shape of about .35 inches wide and .67 inches long.

In some variations, the femoral nerve can comprise an exposed length of about 1 inch and a cross-sectional diameter circular shape of about .08 inches.

FIGS. 1D and 1E illustrate perspective views of the training model of FIG. 1A. The second portion 104 can comprise a recess along its base. The recess can extend transverse to a longitudinal axis of the model 100. The recess can engage with a protrusion 118 on a receiving tray 120 such that the model 100 is lifted during operation.

In some variations, the second portion 104 can comprise a simulated patella having a harder material than a remainder of the synthetic covering 116.

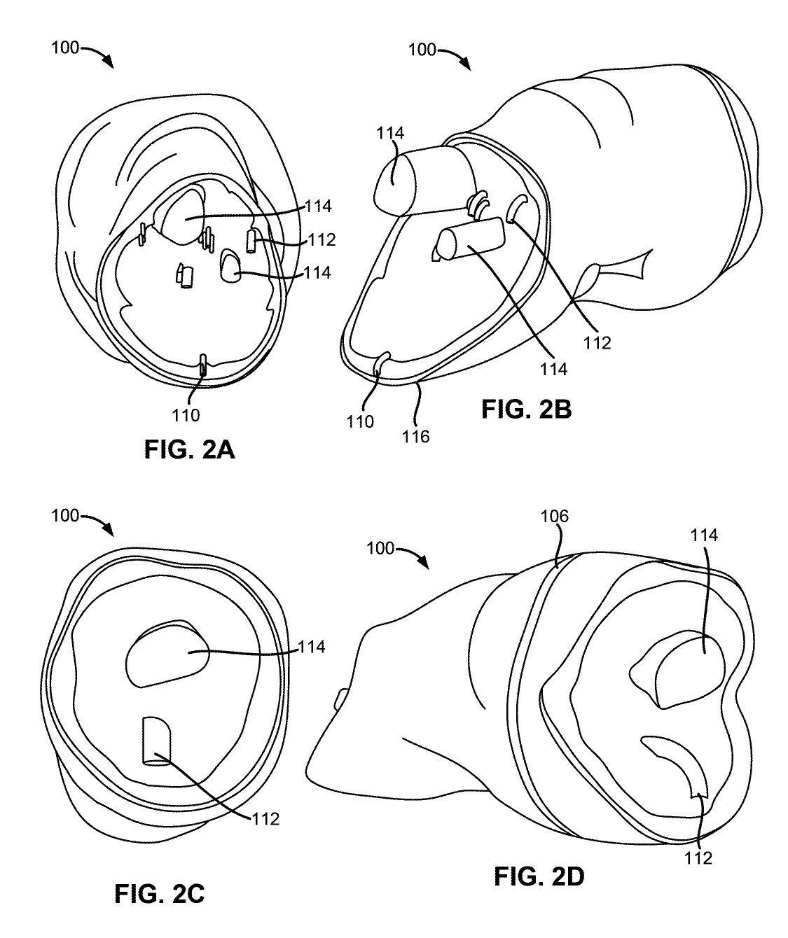

FIGS. 2A and 2B illustrate front and perspective views of the training model below the knee. In this view, the synthetic bones 114, synthetic nerves 110, and synthetic vessels 112 can all be viewed in a proximal direction (i.e., towards the hip). FIGS. 2C and 2D illustrate front and perspective views of the training model above the knee. In this view, the synthetic bones 114, synthetic nerves 110, and synthetic vessels 112 can all be viewed in a distal direction (i.e., towards the foot). It should be understood that both of these views can be accessible to the user simultaneously. When the model 100 is separated via groove 106, the user can access four separate views: proximal and distal views of both the first portion 102 and the second portion 104.

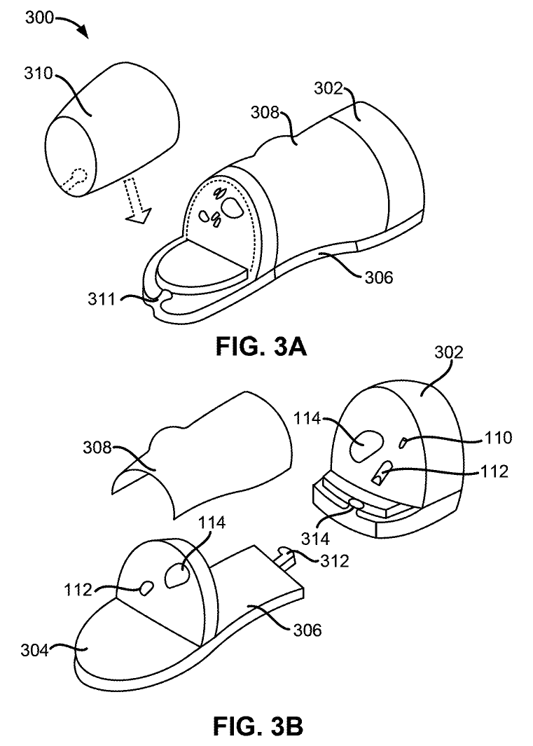

FIGS. 3A and 3B illustrate a training model with interlocking parts according to another variation of the present invention. The model 300 can comprise a first portion 302 and a second portion 304 proximal to the first portion 302.

The first portion 302 and the second portion 304 can be coupled together at a base plate 306 on the first portion 302. The base plate 306 can comprise a male connector 312 configured to made with a female connector 314 on the second portion 304. This connection can lock the model 300 and can be hidden within the model 300 during use.

The model 300 can further comprise a synthetic knee 308 that couples to the first portion 302 and the second portion 304. The synthetic knee 308 can be removably coupled to the model 300 to adjust the nerves, bones or vessels within the model or to detach the first portion 302 from the second portion 304 for versatile use. The synthetic knee 308 can also serve as a cover for the model 300 for pre-amputation training.

The synthetic knee 308 can yield upon amputation to practice pushing a probe into the knee area. Within the model 300 and under the synthetic knee 308 can exist nerves 110, vessels 112, and bones 114 of various sizes to be selected. The user can also adjust nerves within the model 300.

The model 300 can further comprise an insert 310 removably coupled to the first portion 302. The insert 310 can snap into the first portion at a protrusion 311 on the first portion 302. The insert 310 can be used as a space for training for revision procedures in addition to training procedures done on the synthetic knee 308 area.

In some variations, the user can train an AKA revision, which can be performed on an existing stump. The user can interact with tethered nerves laterally from an access window, particularly the sciatic nerve. The nerves can comprise an oval or a circular cross-sectional shape and can have vessels running alongside them for the user to practice separation between the nerves and the vessels. One or more of the nerves can be hidden behind a skin-like flap along the first portion 102 or the second portion 104.

In some variations, the sciatic nerve can comprise an exposed length of about 1 inch and a cross-sectional diameter oval shape of about .35 inches wide and .67 inches long.

A number of embodiments have been described. Nevertheless, it will be understood by one of ordinary skill in the art that various changes and modifications can be made to this disclosure without departing from the spirit and scope of the embodiments. Elements of systems, devices, apparatus, and methods shown with any embodiment are exemplary for the specific embodiment and can be used in combination or otherwise on other embodiments within this disclosure. For example, the steps of any methods depicted in the figures or described in this disclosure do not require the particular order or sequential order shown or described to achieve the desired results. In addition, other steps or operations can be provided, or steps or operations can be eliminated or omitted from the described methods or processes to achieve the desired results. Moreover, any components or parts of any apparatus or systems described in this disclosure or depicted in the figures can be removed, eliminated, or omitted to achieve the desired results. In addition, certain components or parts of the systems, devices, or apparatus shown or described herein have been omitted for the sake of succinctness and clarity.

Accordingly, other embodiments are within the scope of the following claims and the specification and/or drawings can be regarded in an illustrative rather than a restrictive sense.

Each of the individual variations or embodiments described and illustrated herein has discrete components and features which can be readily separated from or combined with the features of any of the other variations or embodiments. Modifications can be made to adapt a particular situation, material, composition of matter, process, process act(s) or step(s) to the objective(s), spirit, or scope of the present invention.

Methods recited herein can be carried out in any order of the recited events that is logically possible, as well as the recited order of events. Moreover, additional steps or operations can be provided or steps or operations can be eliminated to achieve the desired result.

Furthermore, where a range of values is provided, every intervening value between the upper and lower limit of that range and any other stated or intervening value in that stated range is encompassed within the invention. Also, any optional feature of the inventive variations described can be set forth and claimed independently, or in combination with any one or more of the features described herein. For example, a description of a range from 1 to 5 should be considered to have disclosed subranges such as from 1 to 3, from 1 to 4, from 2 to 4, from 2 to 5, from 3 to 5, etc. as well as individual numbers within that range, for example 1.5, 2.5, etc. and any whole or partial increments therebetween.

All existing subject matter mentioned herein (e.g., publications, patents, patent applications) is incorporated by reference herein in its entirety except insofar as the subject matter can conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

Reference to the phrase “at least one of”, when such phrase modifies a plurality of items or components (or an enumerated list of items or components) means any combination of one or more of those items or components. For example, the phrase “at least one of A, B, and C” means: (i) A; (ii) B; (iii) C; (iv) A, B, and C; (v) A and B; (vi) B and C; or (vii) A and C.

In understanding the scope of the present disclosure, the term “comprising” and its derivatives, as used herein, are intended to be open-ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” “element,” or “component” when used in the singular can have the dual meaning of a single part or a plurality of parts. As used herein, the following directional terms “forward, rearward, above, downward, vertical, horizontal, below, transverse, laterally, and vertically” as well as any other similar directional terms refer to those positions of a device or piece of equipment or those directions of the device or piece of equipment being translated or moved.

Finally, terms of degree such as “substantially”, “about” and “approximately” as used herein mean the specified value or the specified value and a reasonable amount of deviation from the specified value (e.g., a deviation of up to ±0.1%, ±1%, ±5%, or ±10%, as such variations are appropriate) such that the end result is not significantly or materially changed. For example, “about 1.0 cm” can be interpreted to mean “1.0 cm” or between “0.9 cm and 1.1 cm.” When terms of degree such as “about” or “approximately” are used to refer to numbers or values that are part of a range, the term can be used to modify both the minimum and maximum numbers or values.

It will be understood by one of ordinary skill in the art that the various methods disclosed herein can be embodied in a non-transitory readable medium, machine-readable medium, and/or a machine accessible medium comprising instructions compatible, readable, and/or executable by a processor or server processor of a machine, device, or computing device. The structures and modules in the figures can be shown as distinct and communicating with only a few specific structures and not others. The structures can be merged with each other, can perform overlapping functions, and can communicate with other structures not shown to be connected in the figures. Accordingly, the specification and/or drawings can be regarded in an illustrative rather than a restrictive sense.

This disclosure is not intended to be limited to the scope of the particular forms set forth, but is intended to cover alternatives, modifications, and equivalents of the variations or embodiments described herein. Further, the scope of the disclosure fully encompasses other variations or embodiments that can become obvious to those skilled in the art in view of this disclosure.

We claim:

1. A surgical leg model for teaching surgical skills, comprising:
a first portion representing an upper end;
a second portion representing a lower end;
a groove between the first portion and the second portion, wherein the groove is breakable to separate the first portion and the second portion;
a silicone material within the first portion and the second portion;
one or more synthetic nerves within the silicone material;
one or more synthetic bones within the silicone material; and
a synthetic covering surrounding the first portion and the second portion, wherein the synthetic covering is open at the upper end and the lower end.

2. The surgical leg model of claim 1, wherein the first portion comprises an open upper end and an open lower end visible when the first portion is separated from the second portion.

3. The surgical leg model of claim 2, wherein the open upper end resembles a distal view above the knee.

4. The surgical leg model of claim 2, wherein the open lower end resembles a proximal view above the knee.

5. The surgical leg model of claim 1, wherein the second portion comprises an open upper end and an open lower end visible when the second portion is separated from the first portion.

6. The surgical leg model of claim 5, wherein the open upper end resembles a distal view below the knee.

7. The surgical leg model of claim 5, wherein the open lower end resembles a distal view below the knee.

8. The surgical leg model of claim 1, wherein the model comprises a base and a recess.

9. The surgical leg model of claim 8, wherein the recess is configured to engage with a protrusion on a receiving tray.

10. The surgical leg model of claim 1, wherein the second portion comprises a simulated patella.

11. The surgical leg model of claim 10, wherein the simulated patella comprises a harder material than a remainder of the synthetic covering.

12. The surgical leg model of claim 1, wherein the synthetic covering is penetrable by a needle.

13. The surgical leg model of claim 1, wherein the one or more synthetic nerves are replaceable within the model.

14. The surgical leg model of claim 1, wherein the one or more synthetic bones are replaceable within the model.

15. The surgical leg model of claim 1, wherein the one or more synthetic nerves are color coded based on their respective nerve.

16. A surgical leg model for teaching surgical skills, comprising:
a first portion representing an upper end, wherein the first portion comprises a first plate;
a second portion representing a lower end, wherein the first portion comprises a second plate, wherein the second plate couples to the first plate;
a muscle flap between the first portion and the second portion, wherein the muscle flap is removable from the first portion and the second portion;
a silicone material within the first portion and the second portion;
one or more synthetic nerves within the silicone material; and
one or more synthetic bones within the silicone material.

17. The surgical leg model of claim 16, wherein the first portion comprises an open upper end and an open lower end visible when the first portion is separated from the second portion.

18. The surgical leg model of claim 17, wherein the open upper end resembles a distal view above the knee, wherein the open lower end resembles a proximal view above the knee.

19. The surgical leg model of claim 16, wherein the second portion comprises an open upper end and an open lower end visible when the second portion is separated from the first portion.

20. The surgical leg model of claim 19, wherein the open upper end resembles a distal view below the knee, wherein the open lower end resembles a distal view below the knee.
